(19) United States
(12) Patent Application Publication
(10) Pub. No.: US 2005/0275720 A1
(43) Pub. Date: Dec. 15, 2005

(54) Monitoring system of specific area

(75) Inventor: Naohei Noguchi, Tokyo (JP)

Correspondence Address: HAYES, SOLOWAY P.C., 3450 E. SUNRISE DRIVE, SUITE 140, TUCSON, AZ, 85718, US

(73) Assignee: DENARO CO., LTD., Tokyo (JP)

(21) Appl. No.: 10/531,806

(22) PCT Filed: Oct. 28, 2002
(86) PCT No.: PCT/JP02/11175

§ 371 Date: Apr. 18, 2005

(51) Int. Cl. H04N 7/18

(52) U.S. Cl. 348/152; 348/143

(57) ABSTRACT

A monitoring system of a specific area comprising monitor terminals each having an image pickup unit and disposed to move on a moving means in an area being monitored, and a monitor which can display at least a monitor image picked up by the image pickup unit. The monitoring system of a specific area further comprises a monitor image switching means for receiving monitor images from the monitor terminals and transmitting the monitor images to the monitor, and a proximity detecting means provided in the monitor terminal for detecting other monitor terminal existing in close proximity on the same or adjacent moving path. When the proximity detecting means detects other monitor terminal, the monitor terminal transmits detection information of other monitor terminal to the monitor image switching means which switches the image being transmitted to the monitor to the monitor image of other monitor terminal based on the received detection information thereof.

### FIELD OF THE INVENTION

The present invention relates to a monitoring system of a specific area, which is capable of performing remote monitoring of a specific area where monitor terminals are disposed, by using a monitoring system such as a telephone and a personal computer that a user has.

### BACKGROUND ART

Due to the deterioration of a security level in recent years, monitoring systems of a specific area have been proposed, by which a user can monitor the condition of the specific area such as the inside of home by using a communication line (including wire and wireless) when necessary or even intermittently frequently not limited to an occasion when the user becomes worried.

However, in these monitoring systems, in order to perform remote monitoring of the specific area to be monitored by monitor images picked up by a monitor terminal having an image pickup unit such as a monitor camera, only a part of the specific area to be monitored can be monitored if only one monitor terminal is provided. Therefore, systems have been proposed where a moving path is provided under a ceiling or the like and a cart or the like mounting the monitor camera thereon can move on the moving path to efficiently perform satisfactory monitoring.

However, in these monitoring systems, there are cases where a plurality of monitor cameras are installed on a same moving path to improve monitoring performance. In this case, there existed a problem that when a first monitor camera moves and comes into contact with another monitor camera, it cannot move forward on the moving path beyond the monitor camera that came into contact, and a monitor image must be switched from the first monitor camera to another monitor camera every time, which was bothersome.

Consequently, the present invention has been created in view of the above-described problem, and it is an object of the invention to provide a monitoring system of a specific area, which does not require bothersome switching when using a plurality of monitor cameras capable of moving on the same moving path.

### DISCLOSURE OF THE INVENTION

To achieve the above-described object, the monitoring system of a specific area is made up of monitor terminals, which have monitoring means having at least an image pickup unit, communication means for transmitting monitor information of the monitor means to an external monitor, and moving means for moving within the area to be monitored, which is made up of a moving cart moving in the moving path that is installed in the area to be monitored, and a monitor, which is data-communicably connected to the monitor terminals and has display means that receives the monitor information transmitted from the monitor terminals and can display at least the monitor image by the image pickup unit, and operating means for operating the movement of the monitor terminals, in which the monitoring system performs remote monitoring of the area to be monitored, where the monitor terminals are installed, by the monitor. The monitoring system is provided with monitor image switching means that switches monitor images from a plurality of the monitor terminals and transmits them to the monitor, in which the monitor terminals have proximity detecting means for detecting another monitor terminal existing in close proximity on a same moving path or an adjacent moving path by moving, the monitor terminal transmits the detection information of another monitor terminal to the monitor image switching means when the proximity detecting means detects another monitor terminal, and the monitor image switching means switches an image to be transmitted to the monitor to the monitor image of another monitor terminal existing in close proximity based on the received detection information of the monitor terminal.

According to this characteristic, when the monitor terminal becomes close to another monitor terminal, the proximity detecting means detects the proximity to transmit it to the monitor image switching means, the monitor image switching means switches the monitor images to be transmitted to the monitor to the monitor image of another monitor terminal, and thus the trouble of switching the monitor image to another monitor terminal can be solved.

In the monitoring system of a specific area of the present invention, it is preferable that the monitor image switching means switch and transmit the image of the monitor terminal, which came close to another monitor terminal by moving, to the monitor to which another monitor terminal has transmitted the monitor image.

With this method, a plurality of monitor terminals can share the moving path, and the monitoring system can be built inexpensively and in a short period comparing to a case of installing plurality of moving paths.

In the monitoring system of a specific area of the present invention, it is preferable that the monitor terminal be made up of a moving unit that is provided with the image pickup unit and moves within the area to be monitored, and a fixed unit that is capable of non-contact communication with the moving units and provided with the communication means.

With this configuration, communication between the moving units and an external monitor can be formed simply via the fixed unit, and the non-contact communication using no cable or the like is employed, so that wear of such cable caused by movement does not occur and labor or cost for maintenance can be drastically reduced.

In the monitoring system of a specific area of the present invention, it is preferable that the moving path have a feeding section for supplying electric power to the moving carts or the moving units.

With this configuration, sufficient electric power can be supplied to the moving cart or the moving unit.

### BRIEF DESCRIPTION OF THE DRAWINGS

FIG. 1 is a block diagram showing the constitution of a monitoring system of a specific area in the embodiment of the present invention.

FIG. 2 is an external perspective view showing a moving unit that constitutes a monitor terminal used in the monitoring system of a specific area in the embodiment of the present invention.

FIG. 3 is a side view showing a moving cart that is connected to the moving unit used in the embodiment of the present invention.

FIG. 4 is a sectional view showing a moving rail and the moving cart, which are moving means used in the embodiment of the present invention.

FIG. 5 is a block diagram showing the constitution of the moving unit that constitutes monitor terminal used in the embodiment of the present invention.

FIG. 6 is a block diagram showing the constitution of a fixed unit that constitutes the monitor terminal used in the embodiment of the present invention.

FIG. 7 is a block diagram showing the constitution of an access module used in the embodiment of the present invention.

FIG. 8 is a block diagram showing the constitution of an administrative computer used in the embodiment of the present invention.

FIG. 9 is an external view showing a personal computer carried by a user, which is capable of outputting the monitor image and sound from the monitor terminal of the embodiment of the present invention.

FIG. 10 is a flow chart showing the flow of monitoring process in the monitoring system of the embodiment of the present invention.

FIG. 11 is a flow chart showing the flow of encryption processing in the monitoring system of the embodiment of the present invention.

FIG. 12 is a flow chart showing the detail flow of the proximity processing in FIG. 10.

FIGS. 13(a) and (b) are views showing tables showing the coordinating relation between moving units 1a and 1b provided inside a fixed unit 2 and a personal computer 15, in the monitoring system of the embodiment of the present invention.

FIGS. 14(a) to (c) are views showing a state where the coordinating relation between the moving units 1a and 1b and the personal computer 15 is changed when two users use the monitoring system of the embodiment of the present invention simultaneously and operate the moving unit 1a or 1b to allow it to exist in close proximity to the other one.

FIGS. 15(a) to (c) are views showing a state where the coordinating relation between the moving units 1a and 1b and the personal computer 15 is changed when one user uses the monitoring system of the embodiment of the present invention and operates the moving unit 1a to allow it to exist in close proximity to the moving unit 1b.

FIGS. 16(a) to (c) are views showing modification examples of a moving rail 102 in the monitoring system of the embodiment of the present invention.

### BEST MODE FOR IMPLEMENTING THE INVENTION

In the following, the embodiment of the present invention will be described based on the drawings.

### EMBODIMENT

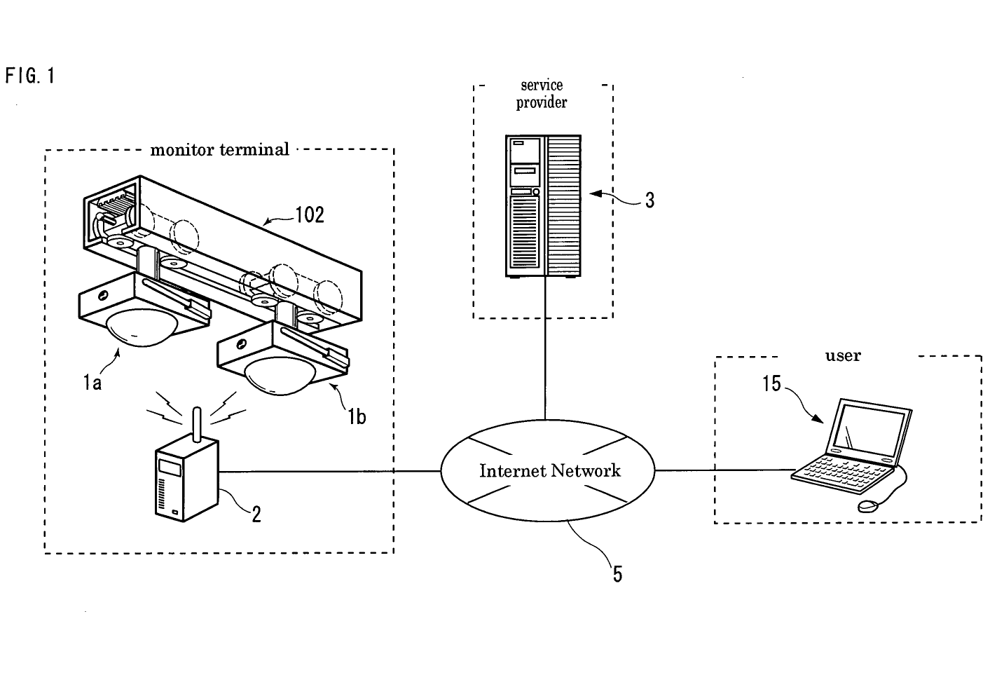

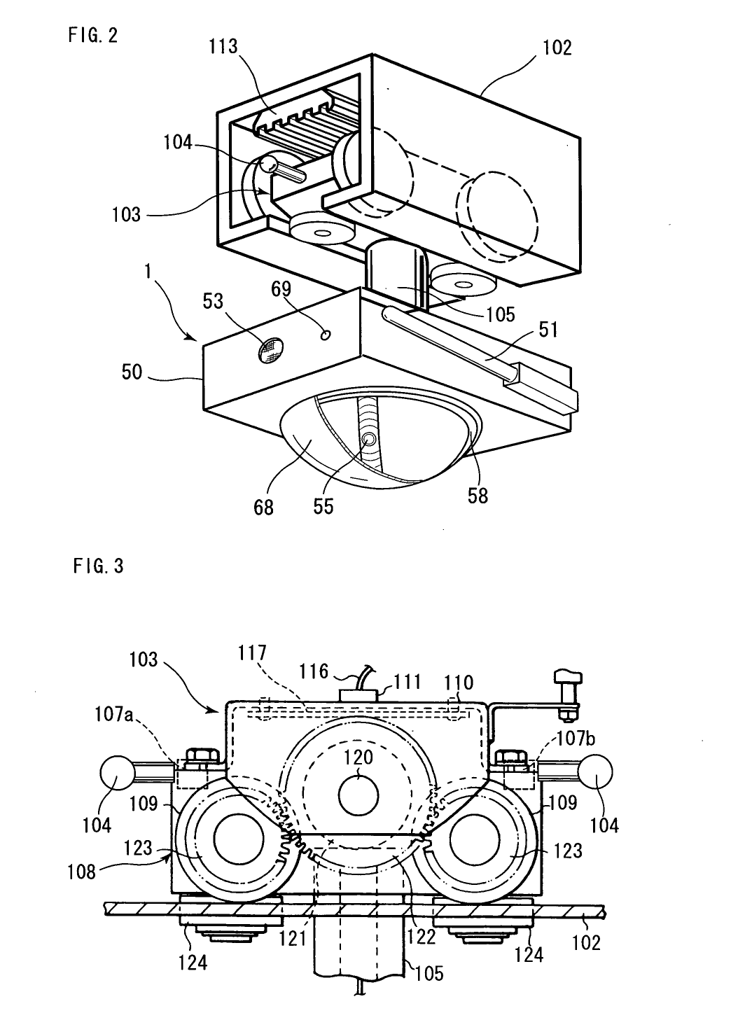

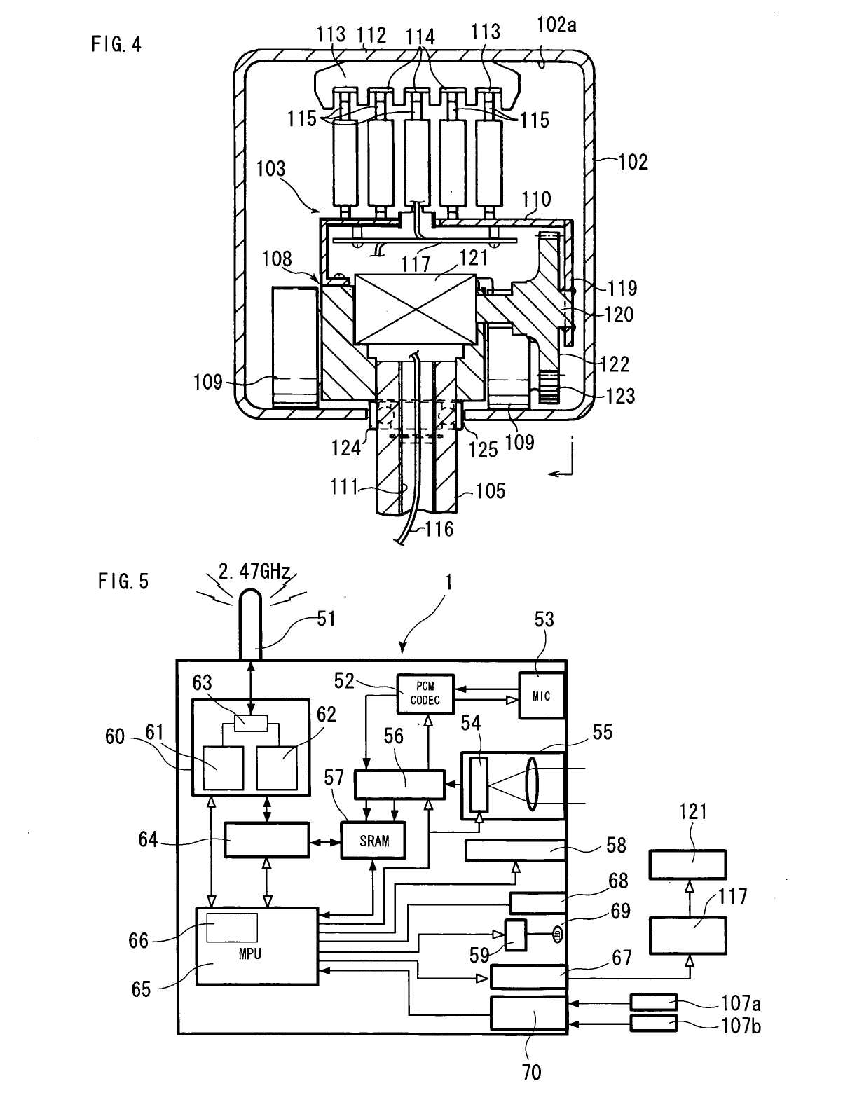

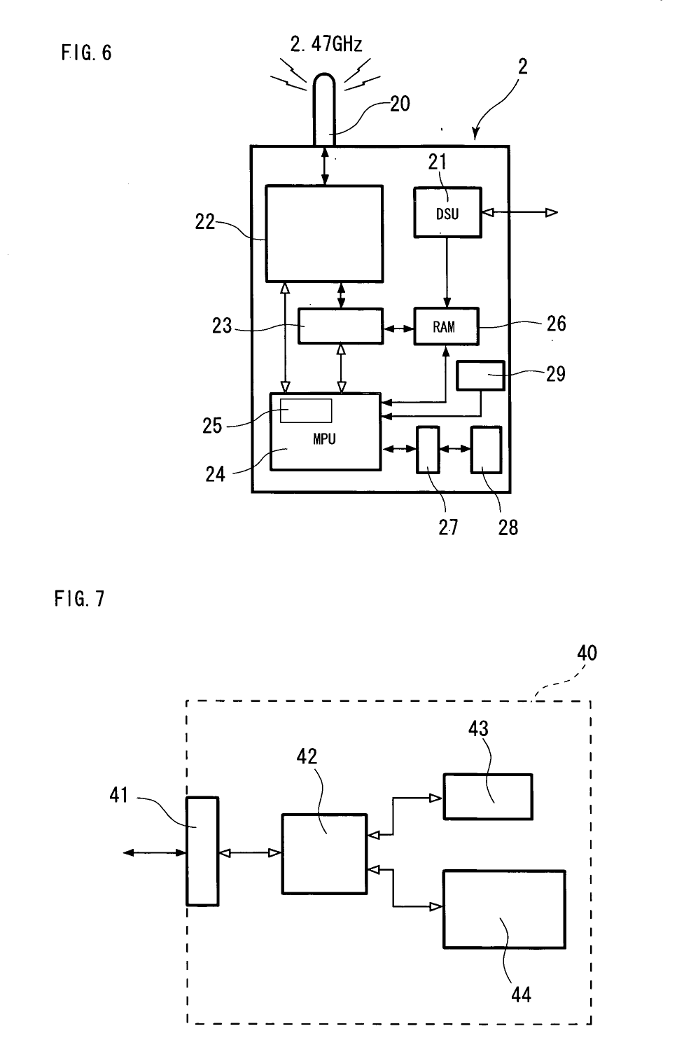

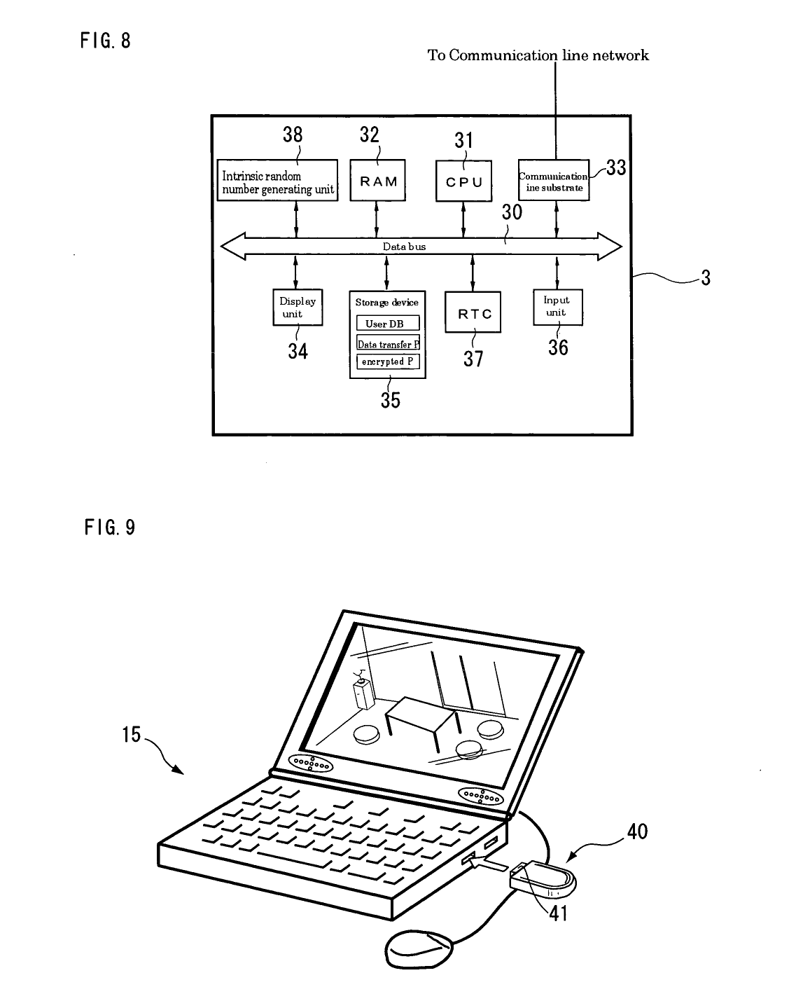

Firstly, FIG. 1 is the block diagram showing the constitution of the monitoring system of a specific area of this embodiment, FIG. 2 is the external perspective view showing the moving unit that constitutes the monitor terminal used in the monitoring system of a specific area of this embodiment, FIG. 3 is the side view showing the moving cart that is connected to the moving unit used in this embodiment, FIG. 4 is the sectional view showing the moving rail and the moving cart, which are the moving means used in this embodiment, FIG. 5 is the block diagram showing the constitution of the moving unit that constitutes the monitor terminal used in this embodiment, FIG. 6 is the block diagram showing the constitution of the fixed unit 2 that constitutes the monitor terminal used in this embodiment, FIG. 7 is the block diagram showing the constitution of the access module used in this embodiment, FIG. 8 is the block diagram showing the constitution of the administrative computer used in this embodiment, and FIG. 9 is the external view showing the personal computer carried by a user, which is capable of outputting the monitor image and sound from the monitor terminal of this embodiment.

Firstly, the monitoring system of a specific area of this embodiment mainly consists of a monitor terminal, which is made up of at least two or more moving units 1 (two units of 1a and 1b in this embodiment), which are installed so as to move on the moving rail 102 installed under the ceiling or the like of a place where the user wants to monitor such as his/her home being an area to be monitored, and the fixed unit 2, an administrative server 3 owned by a service provider, which is data-communicably connected to the monitor terminal and the personal computer 15 that is a monitor owned by the service user via the Internet network 5, and the monitor such as the personal computer 15 operated by the user of monitoring service, as shown in FIG. 1.

Description will be made for the moving units (1a, 1b) used in this embodiment by using FIG. 2 and FIG. 3. The moving units 1a, 1b are connected to moving carts 103 that move in the moving rail 102 installed under the ceiling or the like of the area to be monitored, and are capable of moving within the area to be monitored with the movement of the moving carts 103.

The moving units 1a, 1b each provided with a monitor camera 55 as an image pickup unit and a microphone 53 are installed under the moving carts 103 by a connecting tube 105 in a hanging manner, and the moving units 1a, 1b can also move within the area to be monitored when the moving carts 103 moves in the moving rail 102.

The moving rail 102 and the moving cart 103 which are the moving means used in this embodiment will be described in detail. The moving rail 102 used in this embodiment, as shown in FIG. 2 and FIG. 4, is a square tubular rail shape having an opening slit at the bottom central portion with the sectional view of an approximately horse-shoe shape, and the moving cart 103 can move in the square tubular shaped moving rail 102 with the connecting tube 105 protruded downward from the opening slit.

Further, a feeding bar 113 for supplying electric power to the moving units 1a, 1b is laid under a top surface 112 in the moving rail 102 over the entire length of the panel. By allowing trolleys 115, which are provided on the upper portion of the moving cart 103, to contact the feeding bar 113 in a sliding manner, electric power for moving the moving carts 103 and electric power for activating the moving units 1a, 1b can be supplied from the outside via the feeding bar 113 and the trolleys 115.

Next, description will be made for the moving cart 103 used in this embodiment. In the moving cart 103, running rollers 109 are installed in pairs (right and left) in front and rear on both side surfaces perpendicular to the moving direction of a vehicle body 108 having a drive motor 121 installed therein, and contact members 104 are provided in a pair (front and rear) on both side surfaces in the moving direction of the vehicle body 108.

Gearwheels 123, 123 are provided on one outer surface of the running rollers 109, 109 as shown in FIG. 4, and a drive gearwheel 122 that engages with the both gearwheels 123, 123 is provided at the central position from the both gearwheels 123, 123 as shown in FIG. 3. Since the drive gearwheel 122 is installed to a drive shaft, which transmits power from the drive motor 121 inside the vehicle body 108, in a fixed manner, the torque of the drive motor 121 is transmitted to the running rollers 109 and the moving carts 103 can move in the moving rail 102.

Further, a sensor switch 107a and a sensor switch 107b, which detects contact of another moving cart 103 to the contact member 104 by electric conduction that is caused when a substance contacts the contact member 104 and the member is pushed, are provided inside the contact members 104 as shown in FIG. 3.

Furthermore, the trolleys 115 that contact the feeding bar 113 in a sliding manner are provided on a top panel 110 covering the upper surface of the vehicle body 108 as shown in FIG. 4, and a motor controlling substrate 117, which is connected to the drive motor 121 and controls the operation of the drive motor 121 based on control signals output from MPUs 65, which are provided inside the moving units 1a, 1b, through a connecting cable 116 inserted in the connecting tube 105, is installed on the internal surface in a fixed manner.

Moreover, the motor controlling substrate 117 is also connected to the trolleys 115, where electric power supplied from the feeding bar 113 to the trolleys 115 is supplied to the drive motor 121 via the motor controlling substrate 117, and supplied to the moving units 1a, 1b through the connecting cable 116.

Next, description will be made for the moving units 1a, 1b of this embodiment based on FIG. 5. The moving units 1a, 1b, as shown in FIG. 2, have transparent dome-shaped covers 68 on the lower surface of a box-shaped case 50 that can be arranged at the lower end of the connecting tube 105. The monitor camera 55 being the monitoring means and a direction changing unit 58 capable of changing the monitoring direction of the monitor camera 55 horizontally and vertically are built inside the cover 68, and an antenna 51 for sending and receiving electric waves having a predetermined wavelength to allow the moving units 1a, 1b to perform wireless communication with the fixed unit 2 is provided rotatably on the side surface of the case 50, and the microphone 53 capable of collecting sound of the area to be monitored is provided on another side surface.

Further, the constitution inside the case 50 of the moving units 1a, 1b, as shown in FIG. 5, is made up of a transmission and receiving RF module 60 that is wireless communication means provided with a receiving section 61, a transmission section 62 and an antenna switch 63 for executing transmission and receiving of electric waves in a 2.47 GHz band with the fixed unit 2 via the antenna 51, a modulation and demodulation modem 64 for executing demodulation of electric waves received by the transmission and receiving RF module 60 and modulation of electric waves transmitted from the transmission and receiving RF module 60, a RAM 57 for temporarily storing data transmitted and received by the modem 64, a PCM codec 52 being an A/D converter that is connected to the microphone 53 and converts input sound into digital data, the monitor camera 55 having a charge coupled device (CCD) 54 built therein, which is capable of outputting an image formed inside by a lens as data sequence, a digital signal processor (DSP) 56 that compresses audio data and image data output from the PCM codec 52 and the charge coupled device (CCD) 54 according to a predetermined compression algorithm (MPEG format), the direction changing unit 58 that moves the photographing direction of the monitor camera 55, a driver 59 for turning a pilot lamp (LED) 69 on, and the MPU 65 that is connected to these sections as shown in FIG. 3 and executes processing such as the control of each section. Inside the MPU 65, it has an internal ROM 66 storing a control program or the like therein, in which control contents and the like such as activation and stop of the monitoring means like the monitor camera 55, the direction changing unit 58 and the microphone 53, and peripheral devices of the monitoring means are written, which are executed by the MPU 65. Note that reference numeral 67 in FIG. 5 denotes an output port for outputting control signals to the motor controlling substrate 117, and reference numeral 70 denotes an input port for receiving a signal from the sensor switch 107a and the sensor switch 107b, which shows that the contact member 104 has contacted a substance.

The signal that has input from the input port 70, which shows that the contact member 104 has contacted another moving cart 103, is outputted to the MPU 65, and the MPU 65 that has received the signal transmits transmission data sequence showing that the member has contacted a predetermined another moving cart 103 for a predetermined period from the antenna 51 to the fixed unit 2 via the transmission and receiving RF module 60.

Note that, in this embodiment, the image data and the audio data are transmitted after the data are compressed by MPEG format using the DSP 56 as described above. Performing such data compression is preferable because data capacity to be transmitted is minimized and thus transmission load to the fixed unit 2 and the personal computer 15 being the monitor can be reduced, but the present invention is not limited to this.

Further, the monitor camera 55 and the microphone 53 are provided as the monitoring means in this embodiment, but the present invention is not limited to this. An infrared sensor capable of detecting infrared radiation emitted from an animal or the like, a temperature monitoring sensor (includes fire monitoring sensor by temperature) capable of measuring ambient temperature of an installation location, a smoke monitoring sensor or the like, for example, may be used as the monitoring means, and the monitoring means to be used should be appropriately selected according to a purpose of monitoring.

Next, the fixed unit 2 is in the constitution as shown in FIG. 6, where the unit receives compressed image data and compressed audio data transmitted from the moving units 1a, 1b based on an activation instruction from the administrative server 3, encrypts the compressed image data and the compressed audio data, and transmits the encrypted data to an address of the personal computer 15 which is transmitted from the administrative server 3. The unit is made up of a transmission and receiving RF module 22 for executing transmission and receiving of electric waves in the 2.47 GHz band with the moving units 1a, 1b via an antenna 20, a modulation and demodulation modem 23 for executing demodulation of electric waves received by the transmission and receiving RF module 22 and modulation of electric waves transmitted from the transmission and receiving RF module 22, a RAM 26 for temporarily storing data transmitted and received by the modem 23, a digital service unit (DSU) 21 for executing data communication with computer equipment connected to the Internet network 5 through an ISDN line and an internet service provider (ISP), a display panel 28 that displays information such as communication status in the fixed unit 2, a display driver 27 of the display panel 28, an intrinsic random number generating unit 29 for generating intrinsic random numbers used in encryption processing, and an MPU 24 that is connected to these sections as shown in FIG. 6 and executes processing such as controlling each section and processing of encrypting monitor data to be transmitted and decrypting encrypted data received. Inside the MPU 24, it has an internal ROM 25 storing control program or the like therein, in which various kinds of control contents or the like such as encryption processing executed by the MPU 24 are written.

Next, the constitution of the administrative server 3 that controls access from the personal computer being the monitor to each monitor terminal that is made up of the moving units 1a, 1b and the fixed unit 2 is as shown in FIG. 8. The server is a computer relatively superior in processing performance in which a central processing unit (CPU) 31 superior in processing performance, which is capable of executing various kinds of processing such as authentication processing caused by connection from a user, call to the monitor terminal 1 registered corresponding to the user, connection processing, decryption of received authentication data, and encryption of transmission data, a RAM 32 used as a work memory of the CPU 31, a display unit 34 such as a display, an input unit 36 such as a keyboard and a mouse, a real time clock (RTC) 37 capable of outputting current time information or calendar information such as the day of arbitrary date which is used for registering performance history of connection service or the like, a communication interface 33 capable of executing data communication with the monitor terminal and the personal computer 15 or the like being the monitor of the user in relatively high-speed, an intrinsic random number generating unit 38 for generating intrinsic random numbers used in encryption and decryption, and a storage device 35 that stores a user database (DB) that is made up of a magnetic disc or a magneto-optical disc and with which the password of the user and a fixed IP address attached to the monitor terminal, which is installed at a place where the user wants to monitor, are registered in association with an identification code (ID) by which the user can be identified, a transfer program, in which transfer processing contents are written where the IP address of the authenticated user's personal computer 15 is transferred to the monitor terminal installed at the place where the user wants to monitor to allow the terminal to transmit monitor data including the monitor image to the user's personal computer 15, and an encryption program for executing encryption and decryption of data to be transmitted and received, are connected to a data bus 30 that transmits and receives data in relatively high-speed inside the computer.

Furthermore, as the monitor that the user uses in the present invention, a system having the capability of receiving the encrypted and data-compressed image data and audio data which have been transmitted from the fixed unit 2 constituting the monitor terminal, decrypting the encrypted data, and decompressing the compressed data to reproduce and output is fine. This embodiment uses the personal computer 15 to which an access terminal 40, which generates intrinsic random numbers by which the user decrypts the encrypted image data and audio data and with which the IP address of the administrative server 3 is registered, can be attached as shown in FIG. 9.

A browser software, which is capable of reproducing and displaying the data-compressed image data and audio data which are transmitted from the fixed unit 2, and an encryption program for decrypting the encrypted data being the received data into plain text data are stored inside the personal computer 15. By attaching the access terminal 40 to a USB attaching port provided on a side surface of the personal computer 15, the encryption program encrypts authentication data being the transmission data and decrypts the image data and the audio data which are the receiving data while using intrinsic random numbers output from the access terminal 40.

The constitution of the access terminal 40 used in this embodiment is as shown in FIG. 7, and the terminal is provided with a connector section 41 with which the USB attaching port can be attached, a controller 42 for giving and receiving data with the personal computer 15, a flash memory 43 that is a non-volatile memory in which the IP address of the administrative server 3 and the identification code (ID) of the user can be stored, and an intrinsic random number generating chip 44 that generates intrinsic random numbers.

As the intrinsic random number generating chip 44, it is possible to appropriately use a chip capable of generating completely disordered random numbers that exist in nature unlike pseudo random numbers that are generated in a pseudo manner using a shift register or the like by a program, and Clutter Box (product name of HMI Co., Ltd.) or the like, which generates random numbers by using thermal noise signals caused by resistance heat, is exemplified as the intrinsic random number generating chip 44.

Note that Clutter Box (product name of HMI Co., Ltd.) or the like can be preferably used for the intrinsic random number generating units 29, 38 that are provided in the fixed unit 2 and the administrative server 3 as well.

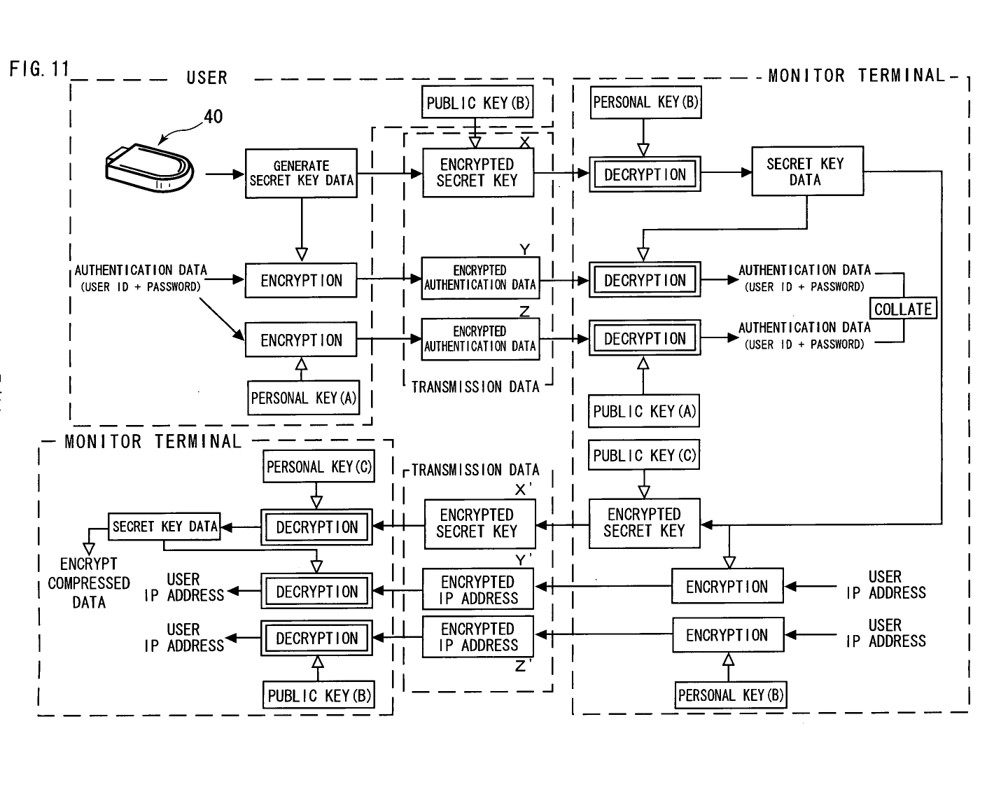

A method of encryption using the intrinsic random numbers will be described by using FIG. 11. Firstly, the personal computer 15, the fixed unit 2, and the administrative server 3 generate an encryption keys (public keys) used for encryption and decryption keys (personal keys) that can decrypt data encrypted by the encryption keys (public keys) by using intrinsic random numbers output from the access terminal 40 and the intrinsic random number generating units 29, 38, and they previously notify a party with which they communicate of the generated encryption keys (public keys) by an electric mail or the like.

Specifically, the personal computer 15 generates public key A and personal key A based on the intrinsic random numbers from the access terminal 40, and previously notifies the administrative server 3 of the generated public key A by the electric mail or the like, and stores personal key A confidentially.

Further, the administrative server 3 similarly generates public key B and personal key B using the intrinsic random numbers output from the intrinsic random number generating unit 38, and previously notifies the personal computer 15 and the fixed unit 2 of the generated public key B by the electric mail or the like, and stores personal key B confidentially.

Furthermore, the fixed unit 2 similarly generates public key C and personal key C using the intrinsic random numbers output from the intrinsic random number generating unit 29, and previously notifies the administrative server 3 of the generated public key C by the electric mail or the like, and stores personal key C confidentially.

In addition, each public key notified by the electric mail or the like is registered with a key database while coordinated with a user ID or a monitor terminal ID, and used for encryption in the communication to the user or the monitor terminal.

Firstly, when a system user accesses the administrative server 3 to receive authentication, the personal computer 15 encrypts and transmits the user ID stored in the access terminal 40 and the password received by the personal computer 15 as authentication data to the administrative server 3.

The encryption of the authentication data is executed as shown in FIG. 11. Specifically, a secret key is generated based on the intrinsic random numbers output from the access terminal 40, the authentication data is encrypted using the generated secret key, and encrypted data Y is generated.

Further, the secret key used in the encryption of encrypted data Y is encrypted by public key B, which has previously been notified from the administrative server 3 being a transmission destination of encrypted data and registered with the key database, and encrypted secret key X is generated.

Furthermore, the authentication data is encrypted by personal key A that has previously been generated in the personal computer 15, and encrypted data Z is generated.

Encrypted secret key X, encrypted data Y, and encrypted data Z, which have been generated in this manner, are transmitted to the administrative server 3 as transmission data.

The administrative server 3 takes out encrypted secret key X, encrypted data Y, and encrypted data Z from the data received, decrypts encrypted secret key X by personal key B to obtain plain text secret key data, and decrypts encrypted data Y by the secret key data to obtain plain text authentication data. Further, by using public key A, which has previously been notified from the personal computer 15 and registered with the key database of the administrative server 3, the server decrypts the encrypted data Z to obtain plain text authentication data, determines whether or not the authentication data by the encrypted data Z matches the authentication data by the encrypted data Y, and certifies that the plain text authentication data as received data when they match.

The administrative server 3 retrieves whether the user database has the registration that matches the user ID and the password included in the plain text authentication data, extracts the monitor terminal ID of a monitor terminal, which is registered with the user database while coordinated with the user ID to identify an IP address corresponding to the monitor terminal ID, and extracts public key C corresponding to the monitor terminal ID from the key database when they match.

Next, the server encrypts the IP address data of the personal computer 15 of the user who made access by the secret key that has been decrypted from the encrypted secret key X, which has been transmitted from the personal computer 15, to generate encrypted IP address Y′, and encrypts the secret key by the extracted public key C of the monitor terminal to generate encrypted secret key X′.

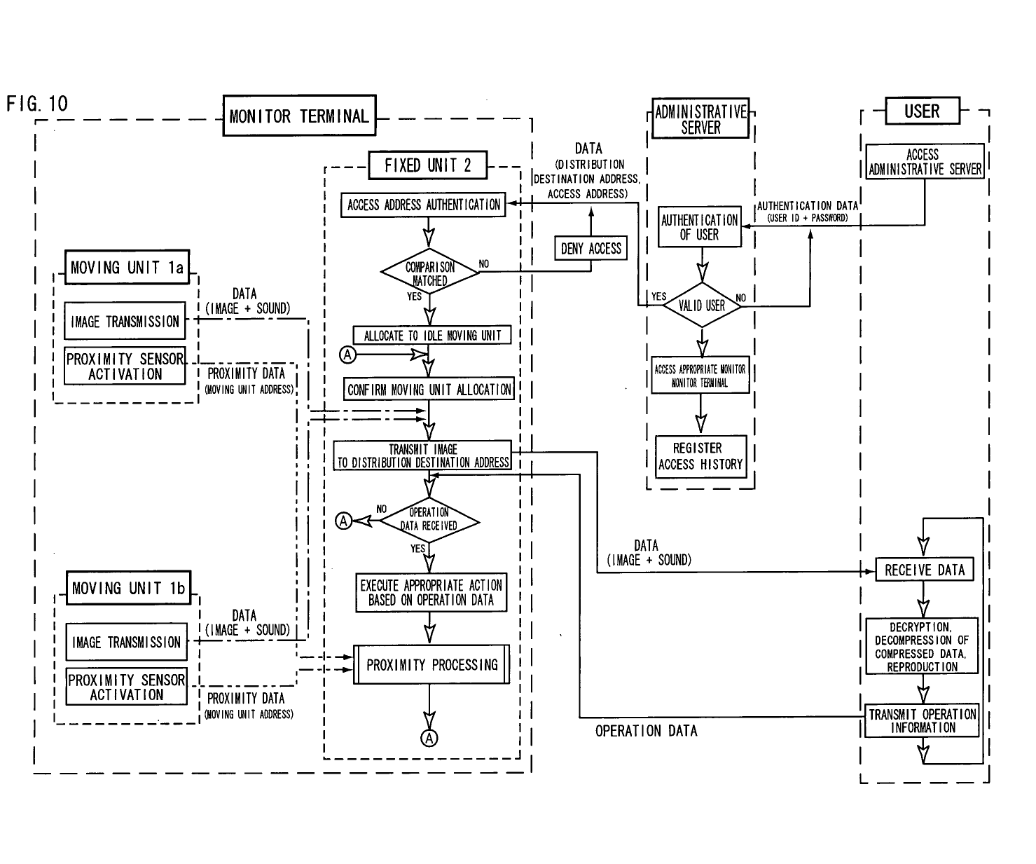

Moreover, the server encrypts the IP address data of the personal computer 15 by personal key B of the administrative server 3 to generate encrypted IP address Z′, transmits encrypted secret key X′, encrypted IP address Y′, and encrypted IP address Z′, which have been generated, as transmitted data to the IP address of the monitor terminal ID identified above (specifically, IP address of the fixed unit 2), and register access history from the personal computer 15 with a history database (refer to FIG. 10).

Meanwhile, if registration that matches the user ID and the password included in the plain text authentication data does not exist in the user database, the server determines that the user is not a valid user, and refuses the access to cut off session.

The fixed unit 2, which has received encrypted secret key X′, encrypted IP address Y, and encrypted IP address Z′ from the administrative server 3, takes out encrypted secret key X′, encrypted IP address Y, and encrypted IP address Z′ severally from the received data, decrypts the encrypted secret key X′ by personal key C that has previously been generated and registered to obtain plain text secret key data, and decrypts encrypted IP address Y′ by the secret key data to obtain plain text IP address. Further, the unit decrypts encrypted IP address Z′ by using public key B that has previously been notified from the administrative server 3 and registered with the key database to obtain plain text IP address. The unit determines whether the IP address by encrypted IP address Z′ matches the IP address by encrypted IP address Y, and determines them as a transmission request of monitor information when they match. The unit activates the moving units 1a, 1b having the monitor cameras 55 and the microphones 53, and encrypts and transmits the compressed monitor image data and audio data, which are transmitted from the moving units 1a, 1b, by using the secret key data decrypted from the encrypted secret key X′ to the decrypted plain text IP address.

The personal computer 15 receives the compressed monitor image data and audio data, which have been encrypted by the secret key data, the encryption is decrypted by the secret key data generated in the personal computer 15 into plain text compressed monitor image data and audio data, and the compressed monitor image data and audio data are reproduced and displayed by the browser.

Based on the display of the monitor image and the reproduction of the sound, the user operates the keyboard to perform instruction operation of a photographing direction and a moving direction.

Such operation information (data) is not encrypted and is transmitted to the IP address of the fixed unit 2 that is the transmission origin of the monitor data, the operation information (data) is transmitted to the moving units 1a, 1b through the fixed unit 2 wirelessly, and thus the MPU 65 executes action that falls under the operation information (data) by outputting control signals to the direction changing unit 58 and the motor control substrate 117.

Description will be made for the state where the user of the monitoring service uses the monitoring system of a specific area of this embodiment and reproduces the image data and the audio data, which have been picked up and collected in the area to be monitored, that is, the monitor data on the personal computer 15 operated by the user based on FIG. 10.

Firstly, the user operates the personal computer 15 and transmits the authentication data that consists of the user ID, the password, and the IP address of the personal computer 15 that is the user IP address to the administrative server 3.

Subsequently, the administrative server 3 checks whether or not the user ID and the passwords received from the personal computer 15 are registered with the user database provided in the storage device 35 (“authentication of user”). When the user ID and the password have been registered, the server certifies that the user as a valid user, and transmits data, which consists of the user IP address received from the personal computer 15 and the IP address of the administrative server 3, that is, an administration IP address, to the fixed unit 2 that includes IP addresses associated with user IDs in the user database from the communication line substrate 33 via the Internet network 5 (“valid user”).

Further, the administrative server 3 accumulates access history showing dates when the user used the monitoring system, that is, data that consists of the user ID and dates in an access history database provided in the storage device 35, and ends processing (“save access history”).

Then, the fixed unit 2 checks whether or not the administration IP address, which has been received by the DSU 21 from the administrative server 3 via the Internet network 5, is the same as an administration IP address written in the RAM 26 (“administration IP address authentication”) to “comparison and matching”). When they are the same, the unit certifies that the data received from the administrative server 3 as valid data, and allocates the user IP address received from the administrative server 3 to a moving unit that is not currently operated by the user, that is, an idle moving unit. Specifically, the MPU 24, by using a moving unit allocation table (described later) provided in the RAM 26, determines that a moving unit that has not transmitted an image to the personal computer 15 at least for a predetermined time (15 minutes in this embodiment) out of the moving unit 1a and the moving unit 1b, which are wirelessly communicably installed via the fixed unit 2 and the antenna 20, as the idle moving unit. By allocating it to the user IP address, the user is allowed to operate the idle moving unit via the personal computer 15 including the user IP address (“allocate to idle moving unit”).

Incidentally, in this embodiment, which one of the moving unit 1a or the moving unit 1b is the idle moving unit or not is determined by whether or not the time when the moving units 1a, 1b do not transmit an image to the personal computer 15 is a predetermine time (15 minutes in this embodiment) or more. However, a constitution may be such that the user can instruct the fixed unit 2 on an operation showing that he/she will stop using the moving units 1a, 1b via the personal computer 15, and the fixed unit 2 determines which one of the moving unit 1a or the moving unit 1b is the idle moving unit or not by whether or not the user showed that he/she would stop using the moving units 1a, 1b.

Next, in the fixed unit 2, the MPU 24 refers to the moving unit allocation table (described later) provided in the RAM 26 to confirm the moving unit IP address of the moving unit 1a, 1b, which is associated with the user IP address, and updates the allocation confirmation time of the moving unit allocation table by current time (“confirm moving unit allocation”). After that, the fixed unit 2 receives the monitor data, which has been picked up and collected from the monitor cameras 55 of the allocated moving unit 1a, 1b, by wireless communication from the allocated moving units 1a, 1b via the antenna 20, and transmits the received monitor data from the DSU 21 to the personal computer 15 via the Internet network 5 (“transmit image to user IP address”).

Next, the personal computer 15 receives the monitor data, which has been picked up and collected by the allocated moving unit 1a, 1b, via the Internet network 5 (“data receiving”), and reproduces it (“decryption, decompression of compressed data, reproduction”). Further, the user executes the instruction operation of the photographing direction and the moving direction corresponding to the reproduced monitor data via the keyboard, and transmits the operation data to the IP address of the fixed unit 2, which is the transmission origin of the monitor data, together with the user IP address via the Internet network 5 (“transmit operation information”).

Subsequently, the fixed unit 2 transmits the received operation data to the moving unit IP address of the moving unit 1a, 1b, which is coordinated with the user IP address that has been received by the DSU 21 via the Internet network 5, in the moving unit allocation table (described later), wirelessly via the antenna 20. The allocated moving unit 1a, 1b that received the operation data is designed to execute the action that falls under the operation data by outputting the control signals for the direction changing unit 58 and the motor control substrate 117 from the MPU 65 (“execute appropriate operation based on operation data”).

Further, in the fixed unit 2, when the contact members 104, which are installed on the side surfaces in the moving direction of the moving unit 1a and the moving unit 1b, contact, that is, come close in the process of executing an operation that falls under the operation data, the MUP 24 executes a proximity processing (described later) where the moving unit IP address coordinated with the user IP address is switched. After completing the proximity processing, process returns to the “moving unit allocation confirmation” step, and the MPU 65 continues processing.

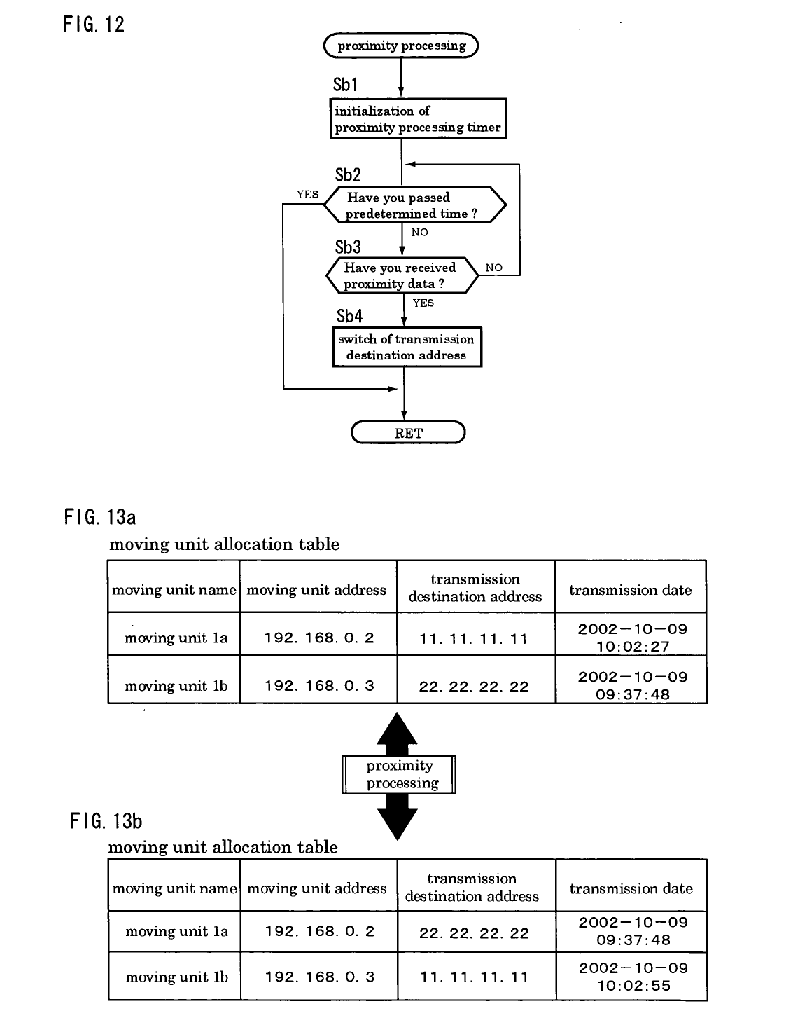

Description will be made for the proximity processing that is executed in the fixed unit 2 and where the moving unit IP address coordinated with the user IP address is switched when the moving unit 1a and the moving unit 1b come close, based on the flow chart of FIG. 12.

Firstly, a proximity processing timer for measuring time taken for the proximity processing provided in the RAM 26 is initialized to 0, and the MPU 24 starts measurement (Sb1).

Subsequently, the proximity processing timer is checked and whether or not the time taken for the proximity processing is a predetermined time (30 seconds in this embodiment) or more is determined (Sb2).

When the time taken for the proximity processing is the predetermined time (30 seconds in this embodiment) or less, the fixed unit 2 becomes standby for proximity data from the moving unit 1a and the moving unit 1b (Sb3). Specifically, in the process where the MPU 65 moves the moving unit 1a and the moving unit 1b based on the instruction operation of moving direction that has been executed by the user via the personal computer 15, when the contact member 104 installed on the side surface in the moving direction of the moving unit 1a, 1b contacts another moving unit 1a, 1b, that is, comes close, the MPU 65 transmits the proximity data, which consists of the moving unit IP addresses included in the contacted moving units 1a, 1b, continuously for the predetermined time (30 seconds in this embodiment) to the fixed unit 2 via the antenna 51. Furthermore, the fixed unit 2, by checking whether or not it received the proximity data via the antenna 20, determines whether or not the user made the moving unit 1a, 1b come close to another moving unit 1a, 1b.

In Sb3 step, when the proximity data has been received, in other words, when the fixed unit 2 has received the moving unit IP address of the moving unit 1a, 1b that came close, the user IP address associated with the received moving unit IP address is determined in the moving unit allocation table (described later) provided in the RAM 26, and the operation data such as the instruction operation for the moving direction, which is transmitted from the user IP address to the fixed unit 2, is identified. After that, the received moving unit IP address and the moving unit IP address included in another moving unit 1a, 1b, which contacts the contact member 104 provided on the side surface on the moving direction side of the moving unit 1a, 1b including the received moving unit IP address, are identified, and coordination between the moving unit IP addresses and the user IP address is exchanged by changing the moving unit allocation table (described later) provided in the RAM 26 to end the proximity processing (Sb4).

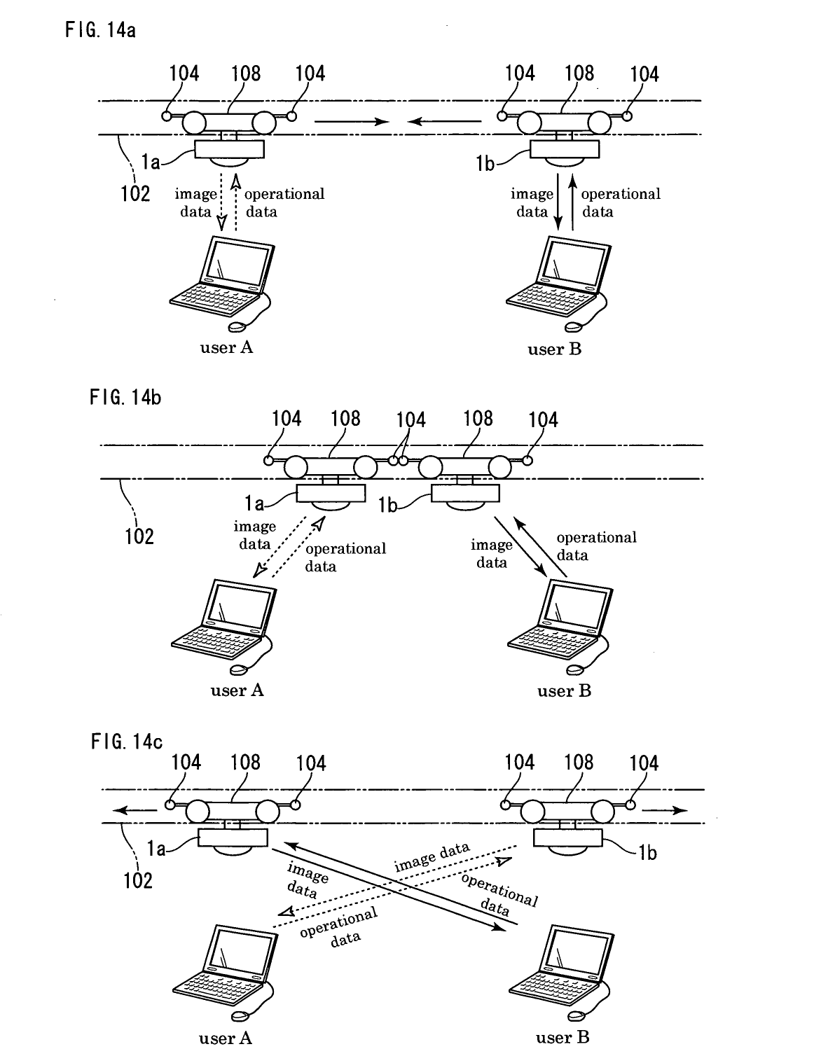

Sb4 step will be described in detail. For example, in the state where the moving unit 1b exists on the right of the moving unit 1a as shown in FIG. 14, when user A operates to move the moving unit 1a to the right and user B operates to move the moving unit 1b to the left (FIG. 14(a)), the contact members 104 provided on the side surfaces in the moving directions of the moving unit 1a and the moving unit 1b eventually contact when the moving operation continues (FIG. 14(b)). By executing the above-described proximity processing substantially simultaneously with the contact, user A operates to move the moving unit 1b to the right and user B operates to move the moving unit 1b to the left, and the user (either A or B) can reproduce the image data picked up by the moving unit 1a, 1b allocated to the user on the personal computer 15 (FIG. 14(c)).

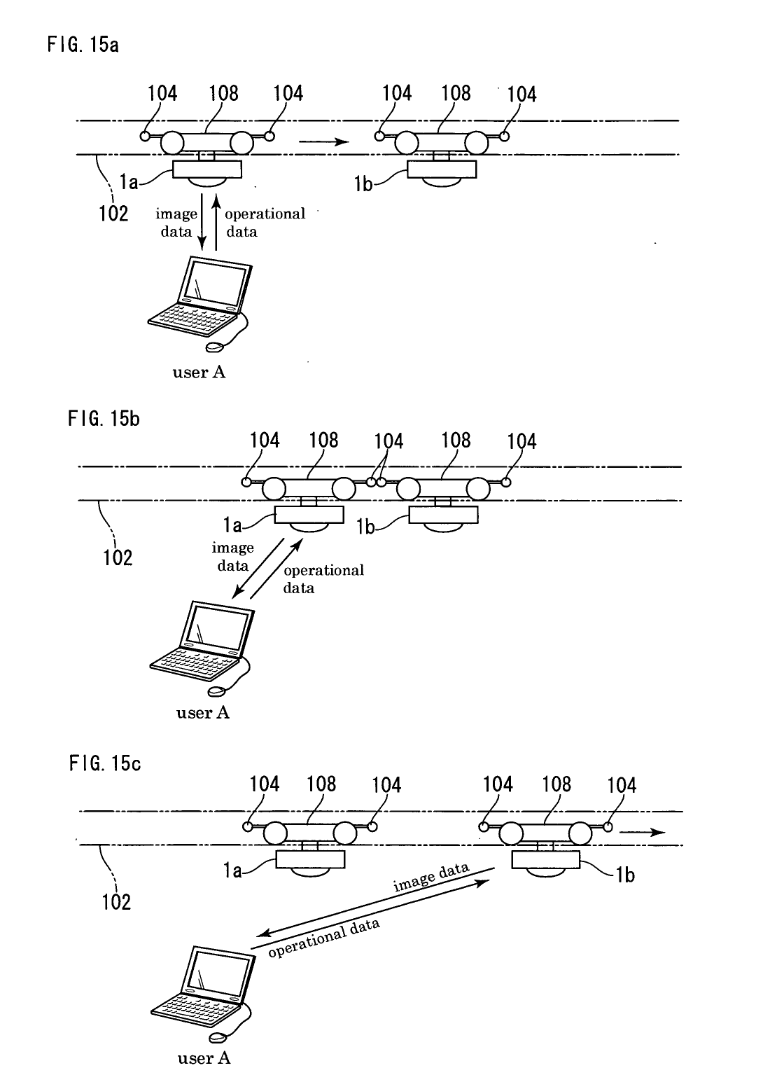

Further, in Sb4 step, in the state where the moving unit 1b exists on the right of the moving unit 1a as shown in FIG. 15, for example, when only user A operates to move the moving unit 1a to the right and no one operates the moving unit 1b (FIG. 15(a)), the contact members 104 provided on the side surfaces in the moving directions of the moving unit 1a and the moving unit 1b eventually contact when the moving operation continues (FIG. 15(b)). By executing the above-described proximity processing substantially simultaneously with the contact, user A operates to move the moving unit 1b to the right, and user A can reproduce the image data picked up by the moving unit 1a, 1b allocated to the user on the personal computer 15 (FIG. 15(c)).

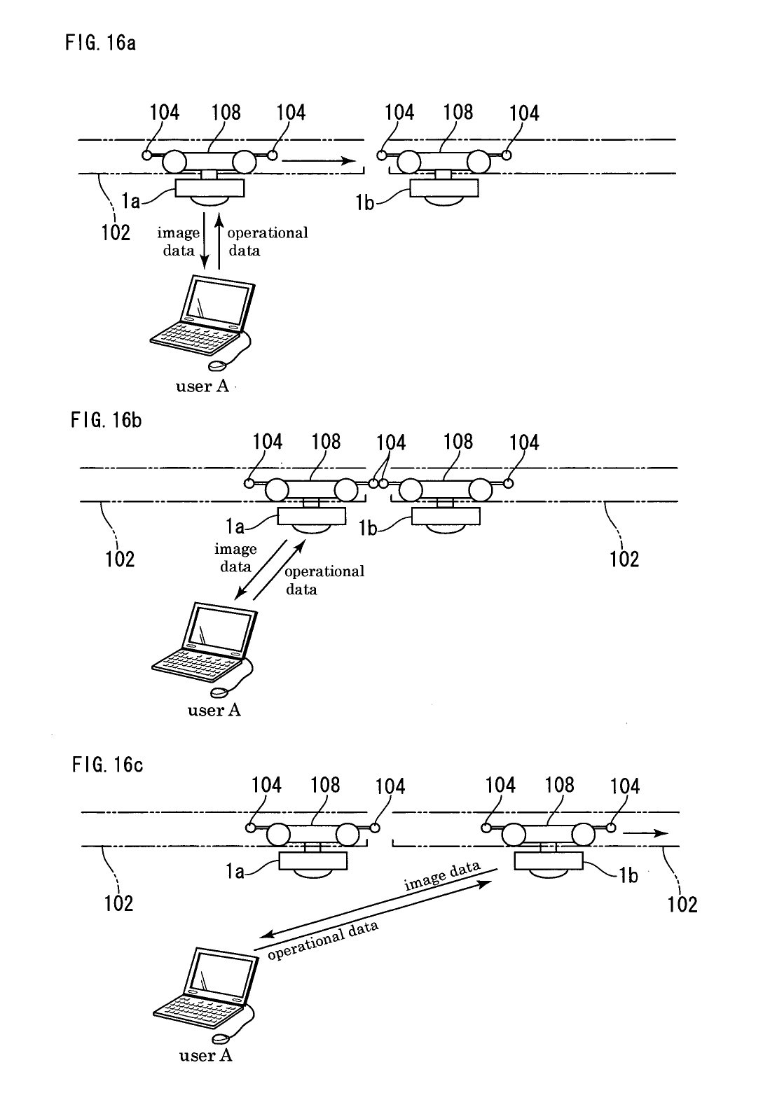

Furthermore, in Sb4 step, two moving rails 102 are installed as shown in FIG. 16, for example, and in the state where the contact members 104 provided on the side surfaces in the moving directions of the moving units 1a, 1b installed on both ends of the moving rails 102 contact, when only user A operates to move the moving unit 1a to the right and no one operates the moving unit 1b (FIG. 16(a)), the contact members 104 provided on the side surfaces in the moving directions of the moving unit 1a and the moving unit 1b eventually contact when the moving operation continues (FIG. 416(b)). By executing the above-described proximity processing substantially simultaneously with the contact, user A operates to move the moving unit 1b to the right, and user A can reproduce the image data picked up by the moving unit 1a, 1b allocated to the user on the personal computer 15 (FIG. 16(c)).

Meanwhile, a constitution is made such that only two moving units 1 (1a, 1b) are installed wirelessly communicably to one fixed unit 2 in this embodiment, but a constitution where three or more moving units 1 are installed may be taken. When three or more moving units 1 are installed, the proximity processing executed by the fixed unit 2 is that the moving unit IP address received from the moving unit 1 that came close and the moving unit IP address of another moving unit 1, which contacts the contact member 104 provided on the side surface on the moving direction side of the moving unit 1 including the received moving unit IP address, are identified, and coordination between the moving unit IP addresses and the user IP address is exchanged by changing the moving unit allocation table (described later) provided in the RAM 26 to end the proximity processing, similar to the case of two moving units.

Description will be made for a moving unit association table, which is provided in the fixed unit 2, showing the association of the moving unit 1a and moving unit 1b with the user IP address, that is, the allocation status of the user to the moving unit based on FIG. 13.

The moving unit association table is made up of a moving unit names, moving unit IP addresses showing the IP addresses of moving units, user IP addresses showing the IP addresses of the personal computers 15 operated by users, and allocation confirmation time that is updated at the time of moving unit allocation confirmation in the fixed unit 3. Since the moving unit allocation confirmation is executed immediately before image transmission as shown in FIG. 10, the allocation confirmation time shows the latest image transmission time.

FIG. 13a shows that the moving unit 1a having 192.168.0.2 as the IP address is allocated to the user operating the personal computer 15 having 11.11.11.11 as the IP address, and the unit transmitted the image at 10:02:27 on Oct. 9, 2002. Further the figure shows that the moving unit 1b having 192.168.0.3 as the IP address is allocated to the user operating the personal computer 15 having 22.22.22.22 as the IP address, and the unit transmitted the image at 9:37:48 on Oct. 9, 2002.

Further, FIG. 13b shows that the moving unit 1a having 192.168.0.2 as the IP address is allocated to the user operating the personal computer 15 having 22.22.22.22 as the IP address, and the unit transmitted the image at 9:37:48 on Oct. 9, 2002. Further the figure shows that the moving unit 1b having 192.168.0.3 as the IP address is allocated to the user operating the personal computer 15 having 11.11.11.11 as the IP address, and the unit transmitted the image at 10:02:27 on Oct. 9, 2002.

The association between the moving units and the users operating the moving units according to the moving unit allocation table is changed every time when the user IP address is changed during the proximity processing. For example, in the case where the user IP address is changed when the status of the moving unit allocation table is in FIG. 13a, the association is changed to FIG. 13b, and it is changed to FIG. 13a in the case where the user IP address is changed when the status is in FIG. 13b.

Accordingly, in the state where the moving unit 1a cannot monitor the area to be monitored whose image can only be picked up from the right end of the moving rail 102 because the moving unit 1b exists on the right of the moving unit 1a on the moving rail 102 installed under the ceiling of the area to be monitored, when the user tries to monitor the area to be monitored at the right end despite that he/she operates the moving unit 1a, for example, the user only operates the moving unit 1a to move in the right direction and the moving unit to be operated is changed from the moving unit 1a to the moving unit 1b by the proximity processing, so that the user does not need to switch the moving unit manually and the trouble of switching the monitor image to another monitor terminal can be eliminated.

In the foregoing, the gist of the present invention has been described by the drawings, but the present invention is not limited to the embodiments and it goes without saying that modifications and additions within the scope without departing from the gist of the present invention are incorporated in the present invention.

For example, the monitor terminal is made up of the moving units 1 and the fixed unit 2 in the embodiments, but the present invention is not limited to this and it may be single movable monitor terminal.

Further, communication between the moving units 1 and the fixed unit 2 is done by non-contact communication by wireless in the embodiments, but the present invention is not limited to this and contact communication via wire or the feeding bar 113 may be used in the communication, and moreover, an infrared communication method may be used as a non-contact communication mode.

Furthermore, the embodiments show the personal computer 15 as the monitor, but the present invention is not limited to this and a computer terminal capable of displaying the monitor image or the like, which is a cell phone, for example, may be used.

Further, the embodiments have shown an example where the personal computer 15 as the monitor, the administrative server 3, and the fixed unit 2 that constitute the monitor terminal were connected by the Internet network 5, but the present invention is not limited to this and the personal computer 15, the administrative server 3, and the monitor terminal may be connected by a communication line network or the like instead of the Internet network 5.

Further, the embodiments used the moving rail 102 and the moving cart 103 as the moving means, but the present invention is not limited to this and another moving means may be used.

Furthermore, in the embodiments, electric power can be supplied to the moving units 1 from outside by providing the feeding bar 113 inside the moving rail 102, but the present invention is not limited to this and the electric power may be supplied by a battery or the like.

Further, the embodiments have the constitution provided with the administrative server 3 that controls access to the monitor terminal, but the present invention is not limited to this and the constitution may not have the administrative server 3.

Further, the embodiment showed an example where two moving units 1a, 1b existed on the moving rail 102, but the present invention is not limited to this and it goes without saying that the present invention is applicable in the case where more plural numbers of moving units exist.

Still further, in the embodiments, the fixed unit 2 forms the monitor image switching means, but the present invention is not limited to this, and the fixed units 2 are provided on one-to-one for each moving unit on the moving rail 102, the administrative server 3 relays the monitor image and the operation information and switches a transmission destination of the image from each monitor terminal with the proximity of each moving unit, and thus the administrative server 3 may form the monitor image switching means.

### DESCRIPTION OF REFERENCE NUMERALS

1a Moving unit (monitor terminal)
1b Moving unit (monitor terminal)
2 Fixed unit (monitor terminal; monitor image switching means)
3 Administrative server
5 Internet network
15 Personal computer
20 Antenna
21 Digital service unit (DSU)
22 Transmission and receiving RF module
23 Modulation and demodulation Modem
24 MPU
25 Internal ROM
26 RAM
27 Display driver
28 Display panel
29 Intrinsic random number generating unit
30 Data bus
31 Central processing unit (CPU)
23 RAM
33 Communication line substrate
34 Display unit
35 Storage device
36 Input unit
37 RTC
38 Intrinsic random number generating unit
40 Access terminal
41 Connector section
42 Controller
43 Flash memory
44 Intrinsic random number generating chip
50 Case
51 Antenna
52 PCM codec
53 Microphone
54 Charge coupled device (CCD)
55 Monitor camera
56 Digital signal processor (DSP)
57 Flash memory
58 Direction changing unit
59 Driver
60 Transmission and receiving RF module
61 Receiving section
62 Transmission section
63 Antenna switch
64 Modulation and demodulation Modem
65 MPU
66 Internal ROM
67 Output port
68 Cover
69 Pilot lamp (LED)
70 Input port
102 Moving rail (moving means)
103 Transport cart (moving means)
104 Contact member
105 Connecting tube
106 Vehicle body
107a Sensor switch
107b Sensor switch
109 Running roller
110 Top panel
112 Top surface
113 Feeding bar (feeding section)
115 Trolley
116 Connecting cable
117 Motor controlling substrate
121 Drive motor
122 Drive gearwheel
123 Gearwheel

1. A monitoring system of a specific area, comprising:
monitor terminals, which have a monitoring device having at least an image pickup unit, a communication device for transmitting monitor information of the monitoring device to an external monitor, and a moving device for moving within the area to be monitored, which is made up of a moving cart moving in the moving path that is installed in said area to be monitored; and
a monitor, which is data-communicably connected to said monitor terminals and has a display device that receives the monitor information transmitted from the monitor terminal and is capable of displaying at least a monitor image by said image pickup unit, and an operating device for operating the movement of said monitor terminals, in which the monitoring system performs remote monitoring of the area to be monitored where said monitor terminals are installed, by said monitor, wherein
said monitoring system includes a monitor image switching device that switches monitor images from a plurality of said monitor terminals and transmits the images to the monitor, in which
said monitor terminals have a proximity detecting device for detecting another monitor terminal existing in close proximity on a same moving path or an adjacent moving path by moving, the monitor terminal transmits the detection information of another monitor terminal to said monitor image switching device when the proximity detecting device detects another monitor terminal, and
said monitor image switching device switches an image to be transmitted to said monitor to the monitor image of another monitor terminal existing in close proximity based on the received detection information of the monitor terminal.

2. The monitoring system according to claim 1, wherein said monitor image switching device switches and transmits the image of said monitor terminal, which came close to the another monitor terminal by moving, to the monitor to which said another monitor terminal has transmitted the monitor image.

3. The monitoring system of a specific area according to claim 1, wherein said monitor terminal is made up of a moving unit that is provided with said image pickup unit and moves within said area to be monitored, and a fixed unit that is capable of non-contact communication with the moving units and provided with said communication means.

4. The monitoring system of a specific area according to claim 1, wherein said moving path has a feeding section for supplying electric power to said moving carts or said moving units.

5. The monitoring system of a specific area according to claim 2, wherein said monitor terminal is made up of a moving unit that is provided with said image pickup unit and moves within said area to be monitored, and a fixed unit that is capable of non-contact communication with the moving units and provided with said communication device.

6. The monitoring system of a specific area according to claim 2, wherein said moving path has a feeding section for supplying electric power to said moving carts or said moving units.

7. The monitoring system of a specific area according to claim 3, wherein said moving path has a feeding section for supplying electric power to said moving carts or said moving units.
